(19) United States
(12) Patent Application Publication
(10) Pub. No.: US 2014/0208208 A1
(43) Pub. Date: Jul. 24, 2014

(54) VIDEO NAVIGATION THROUGH OBJECT LOCATION

(71) Applicants: Louis Chevallier, La Meziere (FR); Patrick Perez, Rennes (FR); Anne Lambert, Chantepie (FR)

(72) Inventors: Louis Chevallier, La Meziere (FR); Patrick Perez, Rennes (FR); Anne Lambert, Chantepie (FR)

(73) Assignee: Thomson Licesning, Issy de Moulineaux (FR)

(21) Appl. No.: 14/126,494

(22) PCT Filed: Jun. 6, 2012
(86) PCT No.: PCT/EP2012/060723

§ 371 Date: Mar. 17, 2014

(30) Foreign Application Priority Data
Jun. 17, 2011 (EP) 11305767.3

(51) Int. Cl. G06F 3/0484

(52) U.S. Cl. CPC G06F 3/04842
USPC 715/720

(57) ABSTRACT

The present invention relates to a method for navigating in a sequence of images. An image is displayed on a screen. A first object of the displayed image is selected at a first position according to a first input. The first object is moved to a second position according to a second input. At least one image is identified in the sequence of images where the first object is close to the second position. Playback of the sequence of images is started beginning at one of the identified images.

The present invention relates to a method for navigating in a sequence of images, e.g. in a movie and for interactive rendering of the same, specifically for videos rendered on portable devices that allow easy user interaction, and to an apparatus for conducting the method.

For video analysis, different technologies exist. A technology called “object segmentation” is known in the art for producing spatial image segmentations, i.e. object boundaries, based on color and texture information. An object is defined quickly by a user using object segmentation technology, just by selecting one or more points within the object. Known algorithms for object segmentation are “graph cut” and “watershed”. Another technology is called “object tracking”. After an object has been defined by its spatial boundary, the object is tracked automatically in the subsequent sequence of images. For object tracking, the object is typically described by its color distribution. A known algorithm for object tracking is “mean shift”. For increased precision and robustness, some algorithms rely on the object appearance structure. A known descriptor for object tracking is Scale—invariant feature transform (SIFT). A further technology is called “object detection”. Generic object detection technology makes use of machine learning for computing statistical model of the appearance of the object to be detected. This requires many examples of the objects (ground truth). Automatic object detection is done on new images by using the models. Models typically rely on SIFT descriptors. Most common machine learning techniques used nowadays include boosting and support vector machine (SVM). In addition, face detection is a specific object detection application. In this case, the features used are typically filter parameters, more specifically “haar wavelet” parameters. A well known implementation relies on cascaded boosted classifiers, e.g. Viola & Jone.

Users watching video content such as news or documentaries might want to interact with the video by skipping some segment or going directly to some point. This possibility is even more desirable when using a tactile device such as a tablet used for video rendering that makes it easy to interact with the display.

For making this non linear navigation possible several means are available on some systems. A first example is skipping a fixed amount of playback time, e.g. moving forward in the video for 10 or 30 seconds. A second example is to make a jump to the next cut or to the next group of pictures (GOP). These two cases provide a limited semantic level of the underlying analysis. The skipping mechanism is oriented according to the video data, not according to the content of the movie. It is not clear for the user what image is displayed at the end of the jump. Further, the length of the interval skipped is short.

A third example is that a jump is made to the next scene. A scene is a part of action in a single location in a TV show or movie, composed of a series of shots. When skipping a whole scene, in general this means jumping to a part of the movie where a different action begins, at a different location in the movie. This might be a too long video portion, which is skipped. A user might want to move by finer steps.

On some system where in-depth video analysis is available, some objects or persons can even be indexed. The users can then click on these objects/faces when they are visible on the video, the system can then move to the point where these persons appear again or display additional information on this particular object. This method relies on the number of objects that the system can effectively index. For the time being, there are relatively few detectors compared to the huge variety of objects one can encounter in e.g. an average news video.

It is an object of the invention to propose a method for navigation and an apparatus for conducting the method, which overcomes the limitations outlined above and offers a more user friendly and intuitive navigation.

According to the invention, a method for navigating in a sequence of images is proposed. The method comprises the steps of:
Displaying an image on a screen.
Selecting a first object of the displayed image at a first position according to a first input. The first input is a user input or an input from another device that is connected to the device executing the method.
Moving the first object to a second position according to a second input. Alternatively, the first object is indicated by a symbol, e.g. a cross, a plus or a circle and this symbol is moved instead of the first object itself. The second position is a position on the screen defined by e.g. coordinates. Another way to define the second position is to define the position of the first object in relation to at least one other object in the image.
Identifying at least one image in the sequence of images where the first object is close to the second position.
Starting playback of the sequence of images beginning at one of the identified images. The playback is started at the first image identified to fulfil the condition that the first object and the second object are close to each other. Another solution is that the method identifies all images fulfilling this condition and the user selects one of the images fulfilling the condition to start playback from this image. A further solution is that the image in the sequence of images is used as a starting point for playback, for which the distance between the two objects is the smallest. For defining the distance between the objects, e.g. the absolute value is used. Another way for defining if an object is close to another object is only using X or Y coordinates or weighting the distance in X and Y direction using different weighting factors.

The method has the advantage that a user watching a sequence of images, which is a movie or news program, either being broadcasted or recorded, is navigating through the sequence of images according to the content of the images and is not dependent on some fixed structure of the broadcasted stream which is defined mainly due to technical reasons. Navigation is made intuitive and more user friendly. Preferably, the method is performed in real-time so that the user has the feeling of actually moving the object. By a specific interaction, the user asks for the point in time where the designated object disappears from the screen.

The first input for selecting the first object is clicking on the object or drawing a bounding box around the object. Thus, the user applies commonly known input methods for a man-machine interface. If an indexing exists, the user is also able to choose the objects by this index from a database.

According to the invention, the step of moving the first object to a second position according to a second input includes:
selecting a second object of the displayed image at a third position according to a further input,
defining a destination of the movement of the first object relative to the second object,
moving the first object to the destination.

The step of identifying further includes identifying at least one image in the sequence of images where the relative position of the destination of the first object is close to the position of the second object.

This has the advantage that a user can not only choose a location on the screen which is related to the physical coordinates of the screen, but can also choose a position where he expects the object with respect to other objects in the image. For example, in a recorded soccer game, the first object might be the ball, and the user can move the ball into the direction of the goal as he expects that there is a scene he might be interested in when the ball is close to the goal, because this might be shortly before the team scores or a player kicks the ball over the goal. This kind of navigation by object is completely independent of the coordinates of the screen, but depends on the relative distance of two objects in the image. The position of the destination of the first object being close to the position of the second object also includes that the second object is exactly at the same position as the destination or that the second object overlaps the destination of the moved first object. Advantageously, the size of the objects and their variation over time is considered to define the relative position of two object to each other. A further alternative is that the user selects an object, e.g. a face and then zooms the bounding box of the face in order to define the size of the face. Afterwards, an image is searched in the sequence of images on which the face is displayed at the size or a size close to this size. This feature has the advantage that if e.g. an interview is played back and the user is interested in the speech of a specific person, assuming that the face of this person is displayed almost covering the biggest part of the screen when this person speaks. Thus, an advantage of the invention is that there is an easy method for jumping to a part of the recording where a specific person is interviewed. The first and the second object do not necessarily have to be selected in the same image of the sequence of images.

The further input for selecting the second object is clicking on the object or drawing a bounding box around the object. Thus, the user applies commonly known input methods for a man-machine interface. If an indexing exists, the user is also able to choose the objects by this index from a database.

For selecting the objects, object segmentation, object detection or face detection is employed. When the first object is detected, object tracking techniques are used to track the position of this object in the subsequent images of the sequence of images. Also key-point technique is employed for selecting an object. Further, key-point description is used for determining the similarity of objects in different images in the sequence of images. A combination of the above mentioned techniques for selecting, identifying and tracking an object is used. Hierarchical segmentation produces a tree whose nodes and leaves correspond to nested areas of the images. This segmentation is done in advance. If a user selects an object by tapping to a given point of an image, the smallest node containing this point is selected. If a further tap of the user is received, the node selected with the first tap is considered as father of the node selected with the second tap. Thus, the corresponding area is considered to define the object.

According to the invention, only a part of the images of the sequence of images are analyzed for identifying at least one image where the object is close to the second position. This part to be analyzed is a certain number of images following the actual image, the certain number of images representing a certain playback time following the currently displayed image. Another way to implement the method is to analyze all following images from the currently displayed image or all previous images from the currently displayed image. This is a familiar way for a user to navigate in a sequence of images as it represents a fast forward or fast backward navigation. According to another implementation of the invention, only I or only I and P pictures or all pictures are analyzed for the object based navigation.

The invention further concerns an apparatus for navigation in a sequence of images according to the above described method.

For better understanding the invention shall now be explained in more detail in the following description with reference to the figures. It is understood that the invention is not limited to this exemplary embodiment and that specified features can also expediently be combined and/or modified without departing from the scope of the present invention.

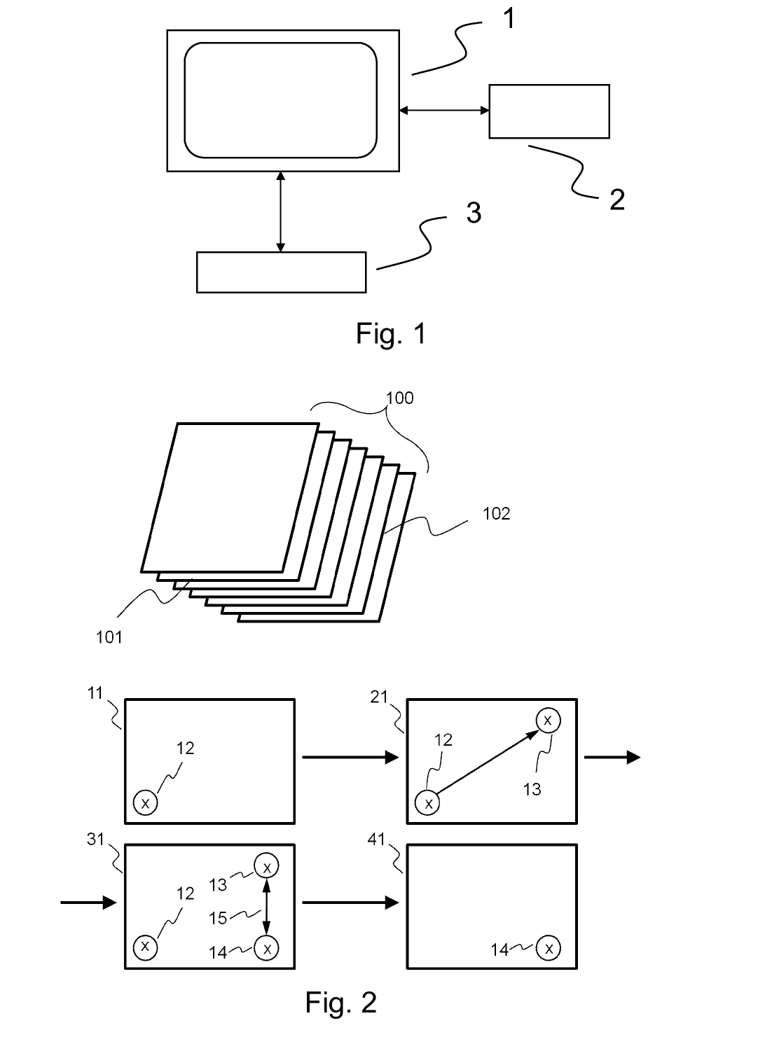

FIG. 1 shows an apparatus for playback of a sequence of images and for performing the inventive method

FIG. 2 shows the inventive method for navigating

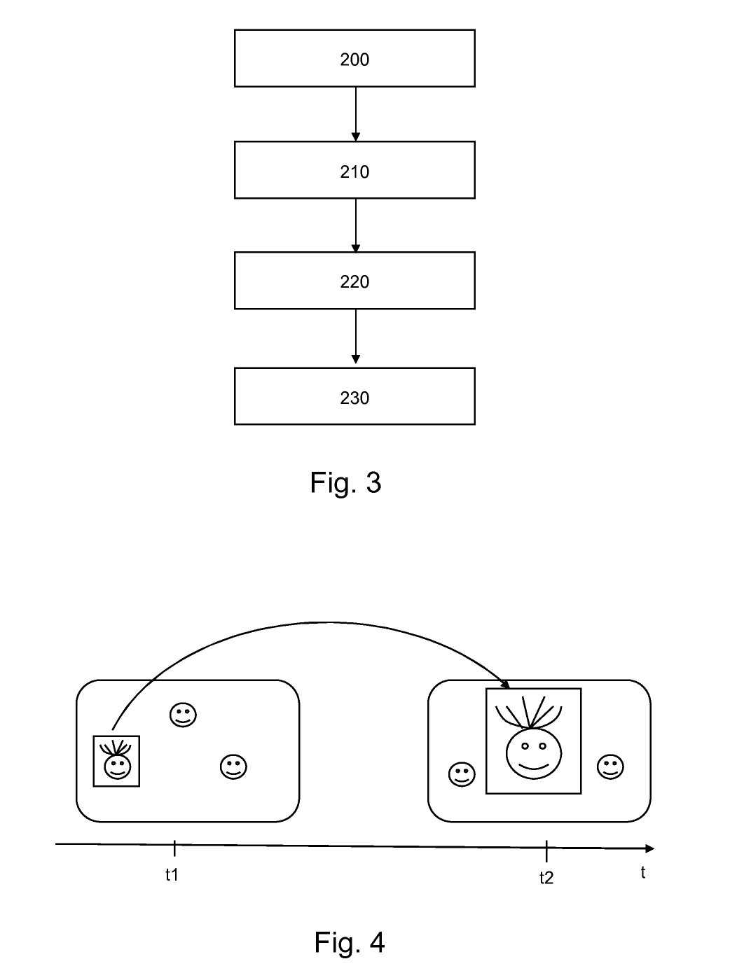

FIG. 3 shows a flow chart illustrating the inventive method

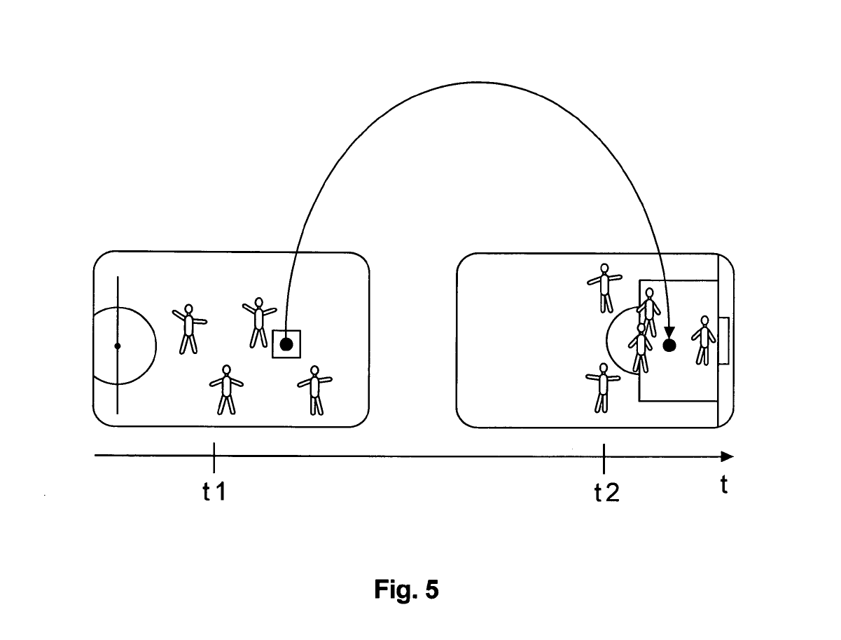

FIG. 4 shows a first example of navigation according to the inventive method

FIG. 5 shows a second example of navigation according to the inventive method

FIG. 1 schematically depicts a playback device for displaying a sequence of images. The playback device includes a screen 1, a TV receiver, HDD, DVD, BD player or the like as source 2 for a sequence of images and a man-machine interface 3. The playback device can also be an apparatus including all functions, e.g. a tablet, where the screen is also used as man-machine interface (touchscreen) and a hard disc or flash disc for storing a movie or documentary is present and a broadcast receiver device is also included into the device.

FIG. 2 shows a sequence of images 100, e.g. of a movie, documentary or sports event, comprising multiple images. The image 101, which is currently displayed on the screen, is a starting point for the inventive method. In the first step, the screen view 11 displays this image 101. A first object 12 is selected according to a first input received from the man-machine interface. Then, this first object 12 or a symbol representing this first object is moved to another location 13 on the screen, e.g. by drag and drop according to a second input received by the man-machine interface. On screen view 21, the new location 13 of the first object 12 is illustrated. Then, the method identifies at least one image 102 in the sequence of images 100 in which the first object 12 is at a location 14 that is close to the location 13 where this object has been moved to. In this image, the location 14 has a certain distance 15 to the desired location 13, indicated by the drag and drop movement. This distance 15 is used as a measure for evaluating how close the desired position and the position in the examined image are. This is illustrated on screen view 31. After identifying the best image, according to the user request, this image is displayed on screen view 41. This image has a certain position, shown as image 102, in the sequence of images 100. The sequence of images 100 is played back from this certain location.

FIG. 3 illustrates the steps which are performed by the method. In the first step 200, an object is selected in a displayed image according to a first input. The input is received from a man-machine interface. It is assumed that the selecting process described is performed in a short time period. This ensures that the object appearance does not change too much. In order to detect the selected object, an image analysis is performed. The image of the current frame is analyzed and the point of interest, which captures a set of key-points present in the image, is extracted. These key-points are located where strong gradients are present. These key-points are extracted with a description of the surrounding texture. When a position in the image is selected, the key-points around this position are collected. The radius of the area in which key-points are collected is a parameter of the method. The selection of the key-points is assisted by other methods, e.g. by a spatial segmentation. The set of extracted key-points constitute a description of the selected object. After selecting the first object, the object is moved to a second position in step 210. This movement is executed according to a second input, which is an input from the man-machine interface. The movement is realized as drag and drop. Then, the method identifies in step 220 at least one image in the sequence of images in which the first object is close to the second position, which is the image location designated by the user. The object similarity in different images is implemented by a comparison of the set of key-points. In step 230, the method jumps to the identified image and playback is started.

FIG. 4 shows an example of applying the method when watching a talk show, in which multiple people are discussing a selected topic. The playback time of the whole show is indicated by an arrow t. At time t1 the first image is displayed on the screen, the image is including three faces. The user is interested in the person displayed on the left-hand side of the screen and selects the person by drawing a bounding box around the face. Then the user drags the selected object (the face with fancy hairs) into the middle of the screen and in addition enlarges the bounding box to indicate that he wants to see this person in the middle of the screen and in a close-up view. Thus, an image fulfilling this requirement is searched for in the sequence of images, this image is found at time t2 and this image is displayed and playback is started at this time t2.

FIG. 5 shows an example of applying a method when watching a soccer game. At time t1 a scene of a game in the middle of the field is shown. There are four players, one of them is close to the ball. The user is interested in a certain situation, e.g. in the next penalty. Thus, he selects the ball with the bounding box and tracks the object to the penalty spot to indicate that he wants to see a scene where the ball is exactly at this point. At time t2, this requirement is fulfilled. A scene is displayed where the ball lies on the penalty spot and a player prepares for kicking a penalty. The game is played back from this scene onwards. Thus, the user is able to conveniently navigate to the next scene he is interested in.

1-14. (canceled)

15. Method for navigating in a sequence of images, comprising the steps of:
displaying an image on a screen,
selecting a first object of the displayed image at a first position according to a first input,
moving the first object to a second position according to a second input,
identifying at least one image in the sequence of images where the first object is close to the second position, and
starting playback of the sequence of images beginning at one of the identified images, wherein
moving the first object to the second position includes:
selecting a second object of the displayed image at a third position according to a further input,
defining a destination of the movement of the first object relative to the second object,
moving the first object to the destination, and wherein
the step of identifying includes identifying at least one image in the sequence of images where the relative position of the destination of the first object is close to the position of the second object.

16. Method for navigating according to claim 15, wherein the first input for selecting the first object is one of clicking on the object, drawing a bounding box around the object, and choosing the object by an index.

17. Method for navigating according to claim 15, wherein the second position is defined by coordinates on the screen different from the coordinates of the first position.

18. Method for navigating according to claim 15, wherein the second position is defined with regard to the second object.

19. Method for navigating according to claim 15, wherein the further input for selecting the second object is clicking on the object, drawing a bounding box around the object or choosing the object in an index.

20. Method for navigating according to claim 15, wherein the objects are selected by object segmentation, object detection or face detection.

21. Method for navigating according to claim 15, wherein the identifying step includes object tracking for defining the position of the first object in an image of the sequence of images.

22. Method for navigating according to claim 15, wherein key-point technique is used for selecting an object.

23. Method for navigating according to claim 15, wherein key-point technique is used for selecting an object and the key-point description is used for determining the similarity of objects in different images in the sequence of images.

24. Method for navigating according to claim 15, wherein only a part of the images of the sequence of images are analyzed for identifying at least one image where the object is close to the second position.

25. Method for navigating according to claim 24, the part of images of the sequence of images represents one of a certain playback time from the currently displayed image, all following images from the currently displayed image and all previous images from the currently displayed image.

26. Method for navigating according to claim 24, the part of images of the sequence of images represents one of I pictures, B pictures and P pictures.

27. Apparatus for navigation in a sequence of images, wherein the apparatus implements a method according to claim 26.
